(19) United States
(12) Patent Application Publication
(10) Pub. No.: US 2004/0178048 A1
(43) Pub. Date: Sep. 16, 2004

(54) Picker assembly

(75) Inventor: Richardi G. Ursitti, Pasadena, CA (US)

Correspondence Address: Pillsbury Winthrop LLp, Intellectual Property Group, Suite 2800, 725 South Figueroa Street, Los Angeles, CA, 90017-5406, US

(73) Assignee: SDI INDUSTRIES, INC.

(21) Appl. No.: 10/385,115

(22) Filed: Mar. 10, 2003

(51) Int. Cl. B65G 17/20

(52) U.S. Cl. 198/678.1

(57) ABSTRACT

A hook assembly is provided for the offloading of hangers from an overhead conveyer system. The hook assembly may be designed to obviate the need for trolleys in an overhead conveyer system. A system for transporting products on hangers is also provided. The system may include a series of interconnected rails, a movable chain, a pusher dog assembly, at least one track switch and a hook assembly. The pusher dog assembly may be joined to the movable chain, which may, in turn, be disposed parallel to, and above, the series of interconnected rails. The at least one track switch may be designed for the induction or exit of hangers into or from the system. The hook assembly may be joined to an exit rail which may, in turn, be joined to the at least one track switch.

### FIELD OF THE INVENTION

The present invention relates to overhead conveyer systems for the movement of hanging products. In particular, the invention relates to a hook assembly designed for the offloading of garments from an overhead conveyer system.

### BACKGROUND OF THE INVENTION

Overhead conveyer systems are well known in the present state of the art. The systems are used for transporting various types of merchandise, including hanging garments and other products, through manufacturing, warehousing and distribution facilities. Typical overhead conveyer systems are “power and free” systems that push heavy, metal trolleys along a track system. The trolleys carry loads of products, such as garments on hangers (“GOH”).

Power and free conveyer systems employ a system of two, parallel tracks; an upper power track and a lower free track are incorporated. The upper track generally includes a drive chain that engages a component of the trolley, while the trolley's wheels are designed to ride within the free track. The load supported by the trolley (e.g., GOH) is most often suspended below the level of the free track. The drive chain commonly includes a pusher dog that extends downward from the drive chain and engages a part of the trolley that protrudes above the level of the free track. A pusher dog is, generally, a projection that engages and pushes loads along a track or conveyer system. Movement of the trolley is thus accomplished by the mechanized action of the pusher dog on the protruding trolley part.

There are many instances of power and free conveyer systems in the present state of the art. U.S. Pat. No. 6,367,612 to Dosso et al. and U.S. Pat. No. 6,308,637 to Sheets et al. are recent examples. Both of these patents are directed to pusher dog variants that are designed to accomplish the movement of the aforementioned trolleys along a parallel track system. However, references to conveyer systems that are adapted for operation without the use of trolleys are significantly less common.

Power and free overhead conveyer systems are often used in conjunction with high speed hanging garment sorters in the processing of GOH. In such an arrangement, GOH may be uploaded into a power and free system in the receiving area of a warehousing or distribution facility. The power and free system may then be used to transport single units or batches of GOH to the induction stations of the high speed garment sorters in a particular sequence or pattern. The high speed sorters are then used to separate the units or batches of GOH according to criteria such as size, style, color or shipment destination.

The use of power and free overhead conveyer systems that incorporate garment trolleys to move GOH has several disadvantages. High speed garment sorters have a potential throughput of at least 12,000 units per hour. Power and free systems cannot deliver GOH at a matching rate. While power and free systems may be able transport up to 200 garments per minute past a given point, the garment trolleys must be manually offloaded before the GOH can be transferred to the high speed sorters, thus reducing the delivery rate drastically. Therefore, the use of power and free conveyer systems in conjunction with high speed sorters effectively starves the sorters and forces them to run below capacity. This represents an inefficient use of resources and reduces the overall productivity of facilities.

The garment trolleys themselves also present various difficulties. Trolleys represent an added expense for any facility, both in purchase and maintenance costs. Also, conveyer systems incorporating trolleys can be noisy to operate. Further, additional costs are often incurred by users of power and free systems since they must also install a return system for empty trolleys (i.e., so that the trolleys can be conveyed to their starting position once the garments have been manually transferred from the trolleys to the high speed sorters). Finally, the above-mentioned manual offload of garment trolleys from power and free systems is physically demanding and can result in personal injury. The low efficiency of power and free systems and the physically demanding aspect of their use results in high labor costs.

The existing art is therefore not suitable for the task of moving large volumes of GOH or other products in a cost-effective and efficient manner. A high capacity conveyer system is desired that does not incorporate trolleys and that does not require the manual transfer of GOH to high speed hanging garment sorters.

### BRIEF DESCRIPTION OF THE DRAWINGS

FIG. 1 is a side perspective view of a hook assembly in accordance with an embodiment of the present invention.

FIGS. 2a-b illustrate a system for transporting products on hangers in accordance with an embodiment of the present invention. FIG. 2a is a side perspective view of a portion thereof.

FIG. 2b is a top perspective view of a portion thereof.

### DETAILED DESCRIPTION

It has been discovered that the processing of GOH or other products on hangers can best be accomplished through the use of a trolley-less overhead conveyer system. A trolley-less overhead conveyer system in accordance with the present invention may include a series of interconnected rails or rail components whose length and contour may be adapted to the requirements of the facility where they are to be installed. The series of interconnected rails or rail components may include an elongated member or metal extrusion and a plastic member or extrusion that is designed to fit over the elongated member or metal extrusion.

The trolley-less overhead conveyer system may also include an enclosed track, running parallel to and above the series of interconnected rails or rail components, which may house a movable train or power chain. The movable train or power chain may be mounted with pusher dog assemblies that extend downward from the movable train or power chain, towards the series of interconnected rails or rail components. Track switches that provide for the transfer of GOH or other products on hangers onto, or off of, the series of interconnected rails or rail components may also be included. The track switches may also incorporate flexible switch arms, designed to facilitate the movement of components of the track switches. Finally, hook assemblies that mediate the transfer of GOH or other products on hangers from the trolley-less overhead conveyer system to further processing steps may also be included. The hook assemblies may also be known as picker assemblies.

The various components of a trolley-less overhead conveyer system in accordance with the present invention may be suspended above a facility floor, using brackets and support members, at a height that allows GOH or other products on hangers to hang freely from the series of interconnected rails or rail components and that provides operators with easy access. GOH or other products on hangers may be inducted into the system at track switches and then may be conveyed along the series of interconnected rails or rail components by the pusher dog assemblies. At another track switch, GOH or other products on hangers may then be transferred to a hook assembly, where conveyer hooks pick up GOH or other products on hangers and mediate induction into high speed hanging garment sorters. Track switches and hook assemblies may be positioned outside the parallel course of the series of interconnected rails or rail components and enclosed track.

As discussed in more detail below, various different materials and component designs may be suitable for use in association with the present invention. Materials may be chosen and components may be designed to achieve the goal of seamlessly moving GOH or other products on hangers quickly, efficiently, and cost-effectively through various processing steps. Various embodiments of the present invention may be used in garment manufacturing, warehousing and distribution operations. For example, one embodiment may be used in a garment distribution facility to deliver large quantities of GOH to high speed hanging garment sorters. In such an installation, GOH may be inducted into a trolley-less overhead conveyer system at a track switch in a receiving area, it may then be conveyed along a series of interconnected rails or rail components by pusher dog assemblies, it may then be delivered to a hook assembly at another track switch and it then may be inducted into a high speed hanging garment sorter. The high speed sorter may then separate the GOH by, inter alia, shipment destination and may deliver the GOH to suitable sections of a shipping area. One skilled in the art will realize that the trolley-less overhead conveyer system of the present invention may be equally easily adapted to a manufacturing or a warehousing facility, or any other facility for the processing of GOH or other products on hangers.

The trolley-less overhead conveyer system of the present invention may accomplish the movement of GOH without encountering the difficulties of other known overhead conveyer systems. Specifically, the trolley-less system may operate at a capacity (in terms of garments/minute moved past a given point) that more closely matches the capacity of high speed hanging garment sorters, thus preventing the sorters from getting starved and increasing overall facility throughput. A trolley-less overhead conveyer system in accordance with the present invention may transport GOH at a rate of 500 garments per minute past a given point, thus ensuring a constant feed of garments to high speed sorters that operate at a capacity of 12,000 units per hour or more. Thus, the system of the present invention may use resources (such as high speed sorters) more efficiently and may increase the productivity of facilities.

Furthermore, the system of the present invention operates without garment trolleys, thus solving many of the problems presented by known power and free overhead conveyer systems. The system does not require manual offload of trolleys from a conveyer system or manual transfer of GOH from the conveyer system to high speed hanging garment sorters (as required by power and free systems). Instead, seamless operational transfer from the trolley-less overhead conveyer system to the high speed sorters may be provided through the use of the hook assemblies. The seamless transfer of GOH contributes to the increased capacity of the present system over typical power and free conveyer systems. In addition, costs associated with the purchase and maintenance of trolleys and with the installation of trolley return systems are fully eliminated. Finally, labor costs may be saved since operators of the present system need not engage in the physically demanding work of offloading trolleys and transferring GOH and will likely be exposed to a lower rate of personal injuries. Thus, the trolley-less overhead conveyer system of the present invention accomplishes the movement of GOH through various processing steps in manufacturing, warehousing and distribution facilities in a quick, efficient and cost-effective manner when compared to known power and free conveyer systems.

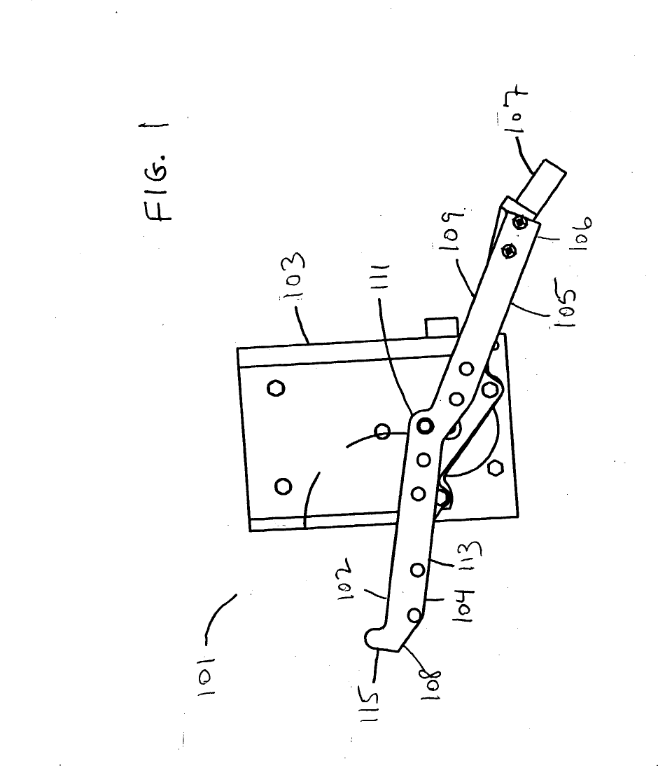

As shown in FIG. 1, one aspect of the present invention may be embodied in a hook assembly 101. The hook assembly 101 may include an attachment housing 103, a hook arm 105 joined to the attachment housing 103 and having a top 102, a bottom 104, a proximal end 106 and a distal end 108, and a rail component adapter 107 joined to the proximal end 106 of the hook arm 105. The hook arm 105 may further include a receiving portion 109 disposed near the proximal end 106, a dividing bridge 111, an offloading portion 113, and a pick up shoe 115 disposed at the distal end 108. The hook arm 105 may have a generally downward sloping orientation when moving in a direction from the receiving portion 109 to the pick up shoe 115. The portion of the dividing bridge 111 closest to the proximal end 106 may have an upward contour and the pick up shoe 115 may be designed in the shape of a hook. The various parts of the hook assembly 101 may be constructed of steel, although one skilled in the art will realize that the hook assembly 101 may be constructed of alternate materials. The hook assembly 101 may be joined to a trolley-less overhead conveyer system at the rail component adapter 107 and may be designed for the offloading of GOH from a trolley-less overhead conveyer system to a high speed hanging garment sorter.

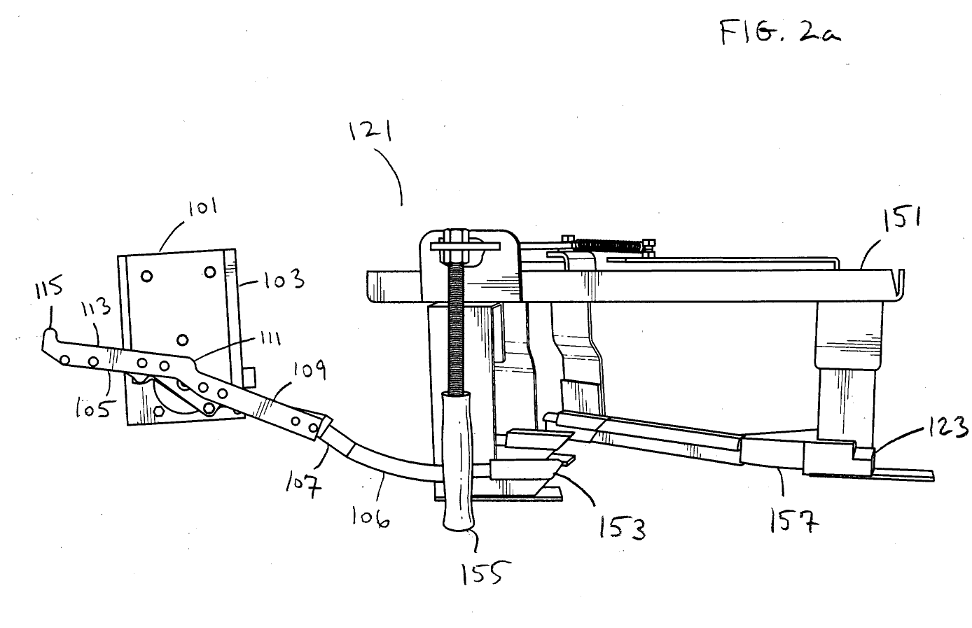

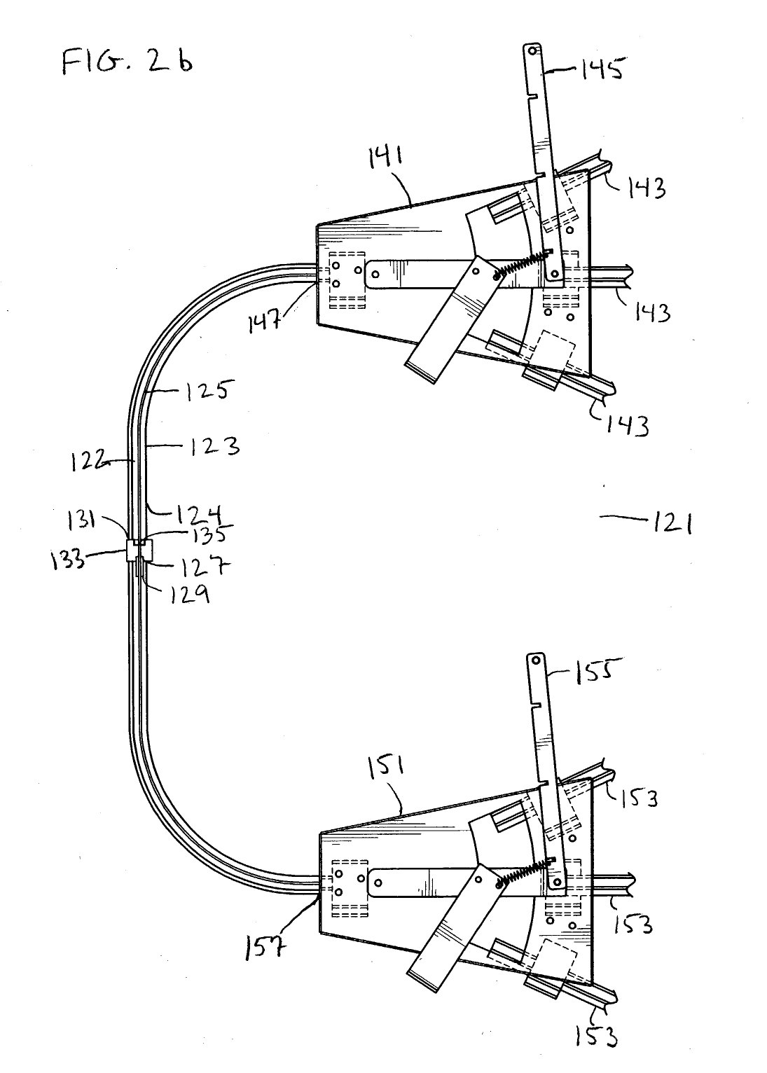

As shown in FIG. 2a, the hook assembly 101 may be included in a system 121 for transporting products on hangers. As shown in FIG. 2b, the system 121 may also include a series of interconnected rails 123 having a top surface 122 and a bottom surface 124, a movable chain 125 disposed parallel to, and above, the series of interconnected rails 123, a pusher dog assembly 127 and a track switch 141. The various components of the system may be suspended above a facility floor by commonly employed means including, but not in any way limited to, the use of brackets and support members.

The pusher dog assembly 127 may be joined to the movable chain 125 and may extend downward toward the series of interconnected rails 123′. The pusher dog assembly 127 may be designed to selectively engage hangers and to push hangers along the top surface 122 of the series of interconnected rails 123. The pusher dog assembly 127 may further include a top end 129, a bottom end 131 and a pusher pad 133 disposed near the bottom end 131, the pusher pad 133 being the point of engagement of the pusher dog assembly 127 with hangers. The pusher pad 133 may further include a stainless steel tip 135 disposed at the bottom end 131, the stainless steel tip 135 being designed to improve the engagement of the pusher pad 133 with hangers and the series of interconnected rails 123 and to reduce friction between the pusher pad 133 and the series of interconnected rails 123.

The track switch 141 may be designed for inducting products on hangers into the system 121 and may further include a plurality of feeder rails 143, means 145 for selectively joining one of said feeder rails 145 to the series of interconnected rails 123, and a flexible switch arm 147.

The flexible switch arm 147 may be configured to allow for the joining of the series of interconnected rails 123 to one of the feeder rails 143. The track switch 141 may be configured so that hangers may be placed on one of the feeder rails 143 and then may be inducted into the series of interconnected rails 123 once the selected feeder rail 143 is joined to the series of interconnected rails 123.

The system may further include an additional track switch 151 that may be designed to facilitate the exit of products on hangers from the system 121. The additional track switch 151 may include a plurality of exit rails 153, means 155 for selectively joining one of said exit rails 153 to the series of interconnected rails 123, and a flexible switch arm 157. The flexible switch arm 157 may be configured to allow for the joining of the series of interconnected rails 123 to one of the exit rails 153. The additional track switch 151 may be configured so that hangers may travel along the series of interconnected rails 123, arrive at the additional track switch 151 and exit the series of interconnected rails 123 onto one of the exit rails 153 once the selected exit rail 153 is joined to the system of interconnected rails 123.

As shown in FIG. 2a, one or more of the exit rails 153 may be joined to a hook assembly 101 by a sloping section of rail component 106. The hook assembly 101 may include an attachment housing 103, a hook arm 105 joined to the attachment housing 103 and having a top 102, a bottom 104, a proximal end 106 and a distal end 108, and a rail component adapter 107 joined to the proximal end 106 of the hook arm 105. The hook arm 105 may further include a receiving portion 109 disposed near the proximal end 106, a dividing bridge 111, an offloading portion 113, and a pick up shoe 115 disposed at the distal end 108. The hook arm 105 may have a generally downward sloping orientation when moving in a direction from the receiving portion 109 to the pick up shoe 115. The portion of the dividing bridge 111 closest to the proximal end 106 may have an upward contour and the pick up shoe 115 may be designed in the shape of a hook. The sloping section of rail component 106 may be joined to the hook assembly 101 by the rail component adapter 107. The sloping section of rail component 106 may be designed with a downward sloping angle of 0-8 degrees, with 6 degrees being optimal. GOH or other products on hangers may be manually or mechanically transported along one of the exit rails 153 toward the sloping section of rail component 106 and then may travel by gravity down the sloping section of rail component 106, past the engagement point of the sloping section of rail component 106 and the rail connecting adapter 107 and onto the top 102 of the hook arm 105. GOH or other products on hangers may then continue traveling by gravity down the receiving portion 109, and be forced to pause by the upward contour of the dividing bridge 111. Finally, GOH or other products on hangers may continue traveling by gravity down the offloading portion 113 and may stop upon arrival at the pick up shoe 115, the hook design of the pick up shoe 115 causing the products on hangers to stop.

Transfer of hangers to a high speed garment sorter may be accomplished by a rotating pawl mechanism that raises the garment hangers above the pick up shoe 115 so that the garment hangers may be engaged by carry hooks of the high speed sorter. The movement of the rotating pawl may be synchronized with the arrival of each carry hook so that garment hangers are inducted into the high speed sorter with a high degree of precision (i.e., without garment hangers falling to the facility floor). The design of the hook assembly 101, and its integration with a system 121 for transporting products on hangers in accordance with the present invention and a high speed hanging garment sorter, may provide for seamless transfer of GOH or other products on hangers from the system 121 for transporting products on hangers to the high speed sorter. This may contribute to the marked increase in speed and efficiency of the system 121 for transporting products on hangers of the present invention (as one example of a trolley-less overhead conveyer system) when compared to conventional power and free systems. The absence of trolleys and the automated transfer of GOH or other products on hangers from conveyer system to high speed sorter saves material and labor costs and matches the hanging product capacity of the system 121 for transporting products on hangers of the present invention with that of known high speed garment sorters. One skilled in the art will realize that the hook assembly 101 may be equally easily integrated with other trolley-less overhead conveyer systems and that such a configuration may confer similar advantages to those discussed herein.

While the description above refers to particular embodiments of the present invention, it should be readily apparent to people of ordinary skill in the art that a number of modifications may be made without departing from the spirit thereof. The accompanying claims are intended to encompass such modifications as would fall within the true spirit and scope of the invention. The presently disclosed embodiments are, therefore, to be considered in all respects as illustrative and not restrictive. Accordingly, the scope of the invention is indicated by the appended claims rather than the foregoing description. All changes that come within the meaning and range of equivalency of the claims are intended to be embraced therein.

What is claimed is:

1. A hook assembly designed for the offloading of hangers from an overhead conveyer system including a series of interconnected rails, comprising:
an attachment housing;
a hook arm having a top, a bottom, a proximal end and a distal end, the hook arm being joined to the attachment housing; and
a rail adapter, the rail adapter being joined to the proximal end of the hook arm, said rail adapter configured to join with the series of interconnected rails of the overhead conveyer system.

2. A system for transporting products on hangers, comprising:
a series of interconnected rails, having a top surface and a bottom surface;
a movable chain, disposed parallel to, and above, the series of interconnected rails;
a pusher dog assembly, the pusher dog assembly being joined to the movable chain and extending downward toward the series of interconnected rails, the pusher dog assembly being designed to selectively engage and push hangers along the series of interconnected rails;
at least one track switch, the at least one track switch being connected to the series of interconnected rails, the at least one track switch comprising a plurality of exit rails, the at least one track switch being designed tofacilitate the exit of hangers from the system;
a sloping section of rail component; and
a hook assembly, the hook assembly being joined to the sloping section of rail component, the hook assembly comprising:
an attachment housing;
a hook arm having a top, a bottom, a proximal end and a distal end, the hook arm being joined to the attachment housing; and
a rail adapter, the rail adapter being joined to the proximal end of the hook arm.
